(19) United States
(12) Patent Application Publication
(10) Pub. No.: US 2019/0147760 A1
(43) Pub. Date: May 16, 2019

(54) COGNITIVE CONTENT CUSTOMIZATION

(71) Applicant: INTERNATIONAL BUSINESS MACHINES CORPORATION, Armonk, NY (US)

(72) Inventors: Kevin Bruckner, Wappingers Falls, NY (US); Robert Paquin, Wappingers Falls, NY (US); Nicole Rae, Millbrook, NY (US); Philip Siconolfi, Wappingers Falls, NY (US)

(21) Appl. No.: 15/809,134

(22) Filed: Nov. 10, 2017

(51) Int. Cl. G09B 7/04; G06N 99/00; G06F 3/01; G09B 5/06; G10L 15/22

(52) U.S. Cl. CPC G09B 7/04; G06N 99/005; G10L 15/22; G09B 5/065; G06F 3/013

(57) ABSTRACT

Systems, methods, and computer-readable media for utilizing a cognitive machine learning model to customize content to enhance a user's comprehension of the content are disclosed herein. The machine learning model may receive a baseline user profile for a user and various other data including, for example, social media data, biometric data, and processed speech data as inputs, and may generate a customized user profile for the user based on the received inputs. The customized user profile may then be used to customize content to obtain customized content for the user designed to enhance the user's comprehension.

### BACKGROUND

Devices that incorporate technical support into curriculum delivery are increasingly being utilized within the classroom environment. These devices can provide such capabilities as voice recording, voice-to-text conversion, and handwriting-to-text conversion, for example. These devices, however, suffer from a number of drawbacks with respect to user comprehension of material presented within the classroom environment, technical solutions to which are described herein.

### SUMMARY

In one or more other exemplary embodiments of the disclosure, a system for generating customized content is disclosed. The system includes at least one memory storing computer-executable instructions and at least one processor configured to access the at least one memory and execute the computer-executable instructions to perform a set of operations. The operations include generating a baseline user profile for a user and providing the baseline user profile as input to a machine learning model. Additional input to the machine learning model can also be provided including at least one of social media data, biometric data, or processed speech data. The operations further include generating a customized user profile for the user based at least in part on the baseline user profile and the additional user input. The operations additionally include customizing content based at least in part on the customized user profile to obtain the customized content for the user and presenting the customized content to the user.

In one or more example embodiments of the disclosure, a method for generating customized content is disclosed. The method includes generating a baseline user profile for a user and providing the baseline user profile as input to a machine learning model. Additional input to the machine learning model can also be provided including at least one of social media data, biometric data, or processed speech data. The method further includes generating a customized user profile for the user based at least in part on the baseline user profile and the additional user input. The method additionally includes customizing content based at least in part on the customized user profile to obtain the customized content for the user and presenting the customized content to the user.

In one or more other exemplary embodiments of the disclosure, a computer program product for generating customized content is disclosed. The computer program product includes a non-transitory storage medium readable by a processing circuit, the storage medium storing instructions executable by the processing circuit to cause a method to be performed. The method includes generating a baseline user profile for a user and providing the baseline user profile as input to a machine learning model. Additional input to the machine learning model can also be provided including at least one of social media data, biometric data, or processed speech data. The method further includes generating a customized user profile for the user based at least in part on the baseline user profile and the additional user input. The method additionally includes customizing content based at least in part on the customized user profile to obtain the customized content for the user and presenting the customized content to the user.

### BRIEF DESCRIPTION OF THE DRAWINGS

The detailed description is set forth with reference to the accompanying drawings. The drawings are provided for purposes of illustration only and merely depict example embodiments of the disclosure. The drawings are provided to facilitate understanding of the disclosure and shall not be deemed to limit the breadth, scope, or applicability of the disclosure. In the drawings, the left-most digit(s) of a reference numeral identifies the drawing in which the reference numeral first appears. The use of the same reference numerals indicates similar, but not necessarily the same or identical components. However, different reference numerals may be used to identify similar components as well. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

FIG. 1 is a schematic hybrid data flow and block diagram illustrating the generation and presentation to a user of customized content in accordance with one or more example embodiments of the disclosure.

FIG. 2 is a process flow diagram of an illustrative method for generating customized content and presenting the customized content to a user in accordance with one or more example embodiments of the disclosure.

FIG. 3 is a process flow diagram of an illustrative method for assessing a comprehension level of a user with respect to customized content presented to the user in accordance with one or more example embodiments of the disclosure.

FIG. 4 is a process flow diagram of an illustrative method for providing data to a content creator to enable the content creator to modify the content to enhance user comprehension in accordance with one or more example embodiments of the disclosure.

FIG. 5 is a schematic diagram of an illustrative networked architecture configured to implement one or more example embodiments of the disclosure.

### DETAILED DESCRIPTION

Example embodiments of the disclosure include, among other things, systems, methods, computer-readable media, techniques, and methodologies for utilizing a cognitive machine learning model to customize content to enhance a user's comprehension of the content. The machine learning model may receive a baseline user profile for a user and various other data including social media data, biometric data, and/or processed speech data as inputs, and may generate a customized user profile for the user based on the received inputs. The customized user profile may then be used to customize content to obtain customized content for the user designed to enhance the user's comprehension. While example embodiments of the disclosure may be described in connection with example use cases involving content consumed within a classroom environment, it should be appreciated that embodiments of the disclosure are applicable to any environment in which content is consumed by users such as, for example, a workplace environment.

Individuals consume new information on a daily basis. This is often a tedious task because such information is not always presented in the most optimally consumable way. Many people have different learning styles and preferences with respect to the way they consume and retain information. At the same time, conventional technologies have failed to adapt to these varied learning styles and preferences to create a personalized learning environment for each user to optimize their consumption and retention of information.

For example, referring to the example use case involving a classroom environment, many students face difficulty organizing information and identifying and comprehending critical concepts presented in a classroom environment. In addition, students may not effectively consume information if the material is not presented in a manner that coincides with their learning styles. While assisted-learning devices and processes exist to improve a student's ability to capture lecture content (e.g., recording devices, transcription technology, etc.), these existing devices and processes suffer from a number of drawbacks including, for example, their inability to provide organizational capabilities for presenting content to a student that is tailored to her personal learning style or preferences.

Example embodiments described herein address these and other drawbacks associated with conventional technologies by providing a cognitive machine learning model that is configured to customize content to enhance a user's comprehension of the content. The cognitive machine learning model may receive a variety of types of inputs including a baseline user profile for a user and other inputs such as social media data, biometric data, or the like that may be used to convert the baseline user profile into a customized user profile for the user. The customized user profile may then be used to customize content in a manner that is specifically tailored to an individual's particular learning style/preferences. For example, the customized user profile can be used to organize verbalized information presented in a classroom environment into critical concepts and present the critical concepts in a manner that is adapted to the student's particular learning style/preferences. The cognitive learning model may be refined over time as inputs to the model change. For example, updated social media data, historical assessment data, etc. may be continually fed to the model to enable the model to dynamically adapt to any changes in a user's learning style/preferences.

More specifically, example embodiments of the disclosure may include collecting verbal information from the user's environment (e.g., a lecturer's speech), performing natural language processing on the captured information to generate processed speech data, and providing the processed speech data as input to the cognitive learning model. The cognitive learning model may identify customizations that may be applied to the processed speech data (and optionally other content captured within the environment such as written content) to organize the content (e.g., highlight the critical concepts and discussion points being presented) in a manner that is adapted to the learning styles/preferences identified in the user's customized user profile. Example embodiments of the disclosure do not merely transform information into a readable format as conventional technologies do, but rather customize content in a manner that enhances a user's comprehension and retention of information based on their profile preferences as well as insights that are derived from a cognitive learning model via the analysis of social media data, historical assessment data, observed patterns in media usage, and the like.

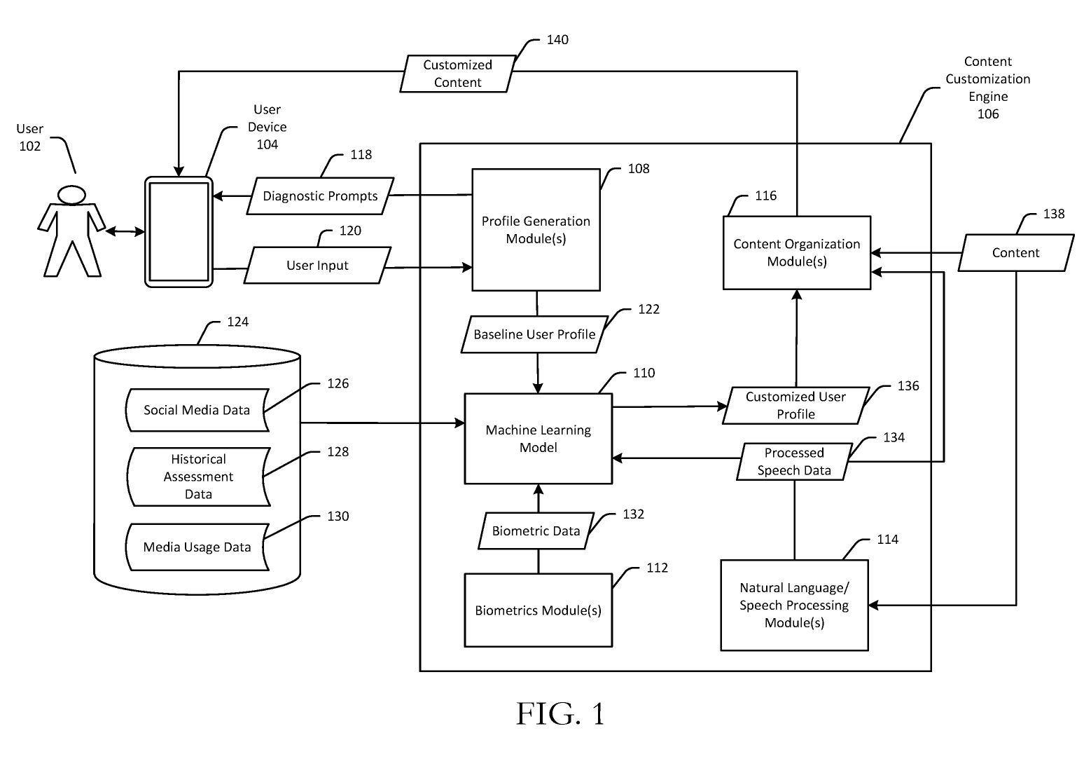

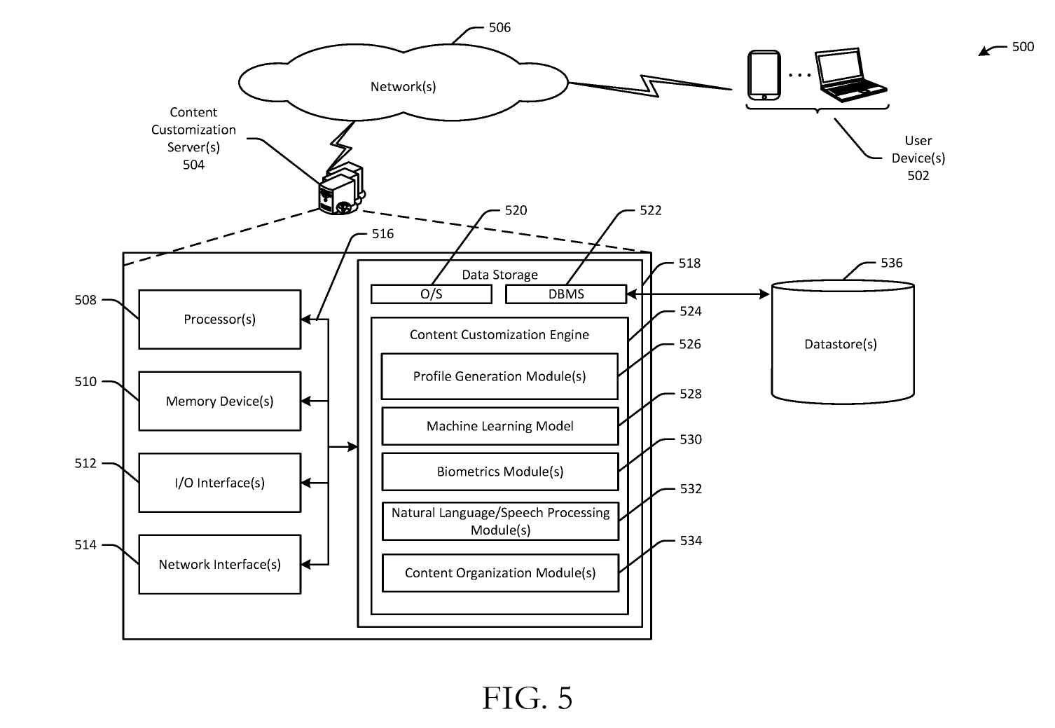

Various illustrative methods of the disclosure and corresponding data structures used in connection with the methods will now be described. It should be noted that each operation of any of the methods 200-400 may be performed by one or more of the engines, program modules, or the like depicted in FIG. 1 or 5, whose operation will be described in more detail hereinafter. These engines, program modules, or the like may be implemented in any combination of hardware, software, and/or firmware. In certain example embodiments, one or more of these program modules may be implemented, at least in part, as software and/or firmware modules that include computer-executable instructions that when executed by a processing circuit cause one or more operations to be performed. A system or device described herein as being configured to implement example embodiments of the disclosure may include one or more processing circuits, each of which may include one or more processing units or nodes. Computer-executable instructions may include computer-executable program code that when executed by a processing unit may cause input data contained in or referenced by the computer-executable program code to be accessed and processed to yield output data.

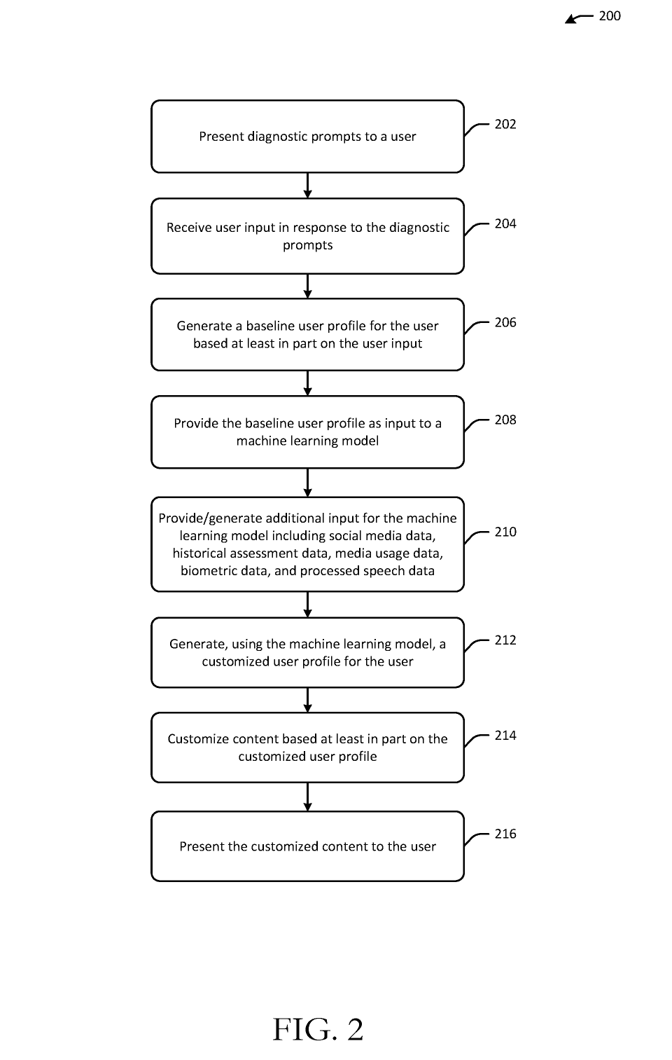

FIG. 1 is a schematic hybrid data flow and block diagram illustrating the generation and presentation to a user of customized content. FIG. 2 is a process flow diagram of an illustrative method 200 for generating customized content and presenting the customized content to a user. FIGS. 1 and 2 will be described in conjunction with one another hereinafter.

Referring first to FIG. 1, a user 102 may utilize a user device 104 to access a content customization engine 106. The content customization engine 106 may reside, for example, on one or more remote servers that the user device 104 may access via one or more networks. In certain example embodiments, the user 102 may utilize the user device 104 to access a client application configured to communicate with the content customization engine 106. The user device 104 may be any suitable device including, without limitation, a desktop computer, a laptop computer, a tablet device, a smartphone, a wearable device, or the like. In certain example embodiments, the client application may communicate with a server-side application that includes or otherwise interfaces with the content customization engine 106. For example, the client application may communicate with the content customization engine 106 via a suitable Application Programming Interface (API). The client application may be a web-based application. In certain example embodiments, the client application may be a web-browser that can be used to access the server-side application. In other example embodiments, the client application may be a mobile application downloaded to a smartphone or tablet device.

Referring now to FIG. 2 in conjunction with FIG. 1, at block 202 of the method 200, diagnostic prompts 118 may be presented to the user 102 via a user interface of the client application accessible on the user device 104. The diagnostic prompts 118 may include any suitable query designed to glean information from the user 102 as to his/her learning style/preferences. For example, the diagnostic prompts 118 may include a set of questions querying the user 102 as to his preferred learning style (e.g., visual, auditory, tactile, etc.). The diagnostic prompts 118 may additionally or alternatively include content presented in different forms followed by questions designed to assess the user's 102 comprehension of the content. User responses to these questions may then be analyzed to identify differences in comprehension based on the form in which the content is presented.

At block 204 of the method 200, user input 120 may be received in response to the diagnostic prompts 118. The user input 120 may include, without limitation, user responses to queries about the user's 102 preferred learning style and/or learning preferences, user responses to queries designed to assess user comprehension of content presented in different forms, and so forth. At block 206 of the method 200, computer-executable instructions of one or more profile generation modules 108 may be executed to generate a baseline user profile 122 for the user 102 based at least in part on the user input 120. The baseline user profile 122 may indicate one or more preferred learning styles for the user 102, which may be determined by the profile generation module(s) 108 based on, for example, which form of content presentation results in the highest number of correct responses from the user 102 (e.g., or a number of responses that meets or exceeds a threshold number), thereby indicating greater comprehension of the content by the user 102. Alternatively, or additionally, self-identification of preferred learning style(s) by the user 102 in response to the diagnostic prompts 118 may be used to generate the baseline user profile 122. The baseline user profile 122 may provide a baseline template to generate or modify content for presentation in a medium (e.g., visual, auditory, tactile, etc.) that is most suited to the user's 102 learning style/preferences. In certain example embodiments, the baseline user profile 122 may be generated when the user 102 initially registers with or otherwise accesses the client application that interacts with the content customization engine 106.

At block 208 of the method 200, the baseline user profile 122 may be provided as input to a cognitive machine learning model 110. In addition to the baseline user profile 122, other inputs may be provided to the machine learning 110 at block 210 of the method 200. These additional inputs may include data pertaining to the user's 102 learning habits, which may be stored in and accessible from one or more datastores 124. Such data may include, without limitation, social media data 126, historical educational assessment data 128, and media usage data 130 indicative of observed patterns in media usage from media sources such as libraries, online repositories, or the like. The additional inputs may also include biometric data 132 captured by one or more biometrics modules 112 and/or processed speech data 134 generated by one or more natural language/speech processing modules 114. At block 212, computer-executable instructions of the machine learning model 110 may be executed to customize the baseline user profile 122 based on the additional input data that is received to obtain a customized user profile 136 for the user 102. The customized user profile 136 may represent an optimal model for the user's 102 learning style.

The social media data 126 may include online articles shared by the user 102 on social media sites, social media posts generated by the user 102, pictures or other media shared by the user 102, or the like. The content of the user's social media activity may be used to learn the machine learning model 110 for the user 102 and generate the customized user profile 136. By gleaning information from the user's social media activity, a personalized learning model can be learned for the user 102. For example, if the user 102 tends to post pictures of historical sites or locations on their social media account(s), this information can be incorporated by the machine learning model 110 into the user's customized user profile 136 such that content relating to historical sites or events later presented to the user 102 can be annotated or otherwise enhanced with pictures of the historical sites or events in order to reinforce concepts and make the content more tailored to the user's 102 interests or preferences. As another non-limiting example, if the user's social media activity indicates an interest in a particular subject matter (e.g., sports), this information can be incorporated into the customized user profile 136 such that content later presented to the user 102 can be modified or enhanced to relate to the subject matter of interest to the user 102. For example, a mathematics word problem can be modified or generated to incorporate a sports-related theme.

The historical assessment data 128 may include, for example, data indicative of previous assessments (e.g., tests, quizzes, projects, etc.) of the user's 102 level of comprehension of material presented in the classroom environment. The historical assessment data 128 may be analyzed to identify areas of strong and weak comprehension by the user 102. These analysis results can be incorporated into the customized user profile 136 such that content later presented to the user 102 can be tailored to reinforce areas of weak comprehension by the user 102 and place less emphasis on areas of strong comprehension by the user 102. In addition, the formatting and organization of past historical assessments can be analyzed to identify any formatting or content presentation aspects that correspond to greater comprehension by the user 102. This information can be incorporated into the customized user profile 136 to enable content later presented to the user 102 to be similarly formatted or organized.

The media usage data 130 may include, without limitation, data indicative of various media sources accessed by the user 102. For example, the media usage data 130 may indicate media (e.g., books, articles, digital media, etc.) accessed by the user 102 from physical repositories such as a public or school library and/or from online sources. As an example, various media accessed by the user 102 can be analyzed to identify content organization, style, and/or formatting that is tailored to the user's learning style/preferences. These user preferences with respect to content organization, style, and/or formatting may be incorporated into the customized user profile 136 for the user 102 and may be used to organize and format content presented to the user. For example, user preferences with respect to content organization, style, and/or formatting may be reflected in various ways including, without limitation, the formality with which text is presented to the user 102; the inclusion of a table and/or summary to provide organizational structure to content; the application of a standard type of formatting to text (e.g., MLA/APA/Chicago style formatting); organization of content into different forms of presentation (e.g., bulleted lists); and other changes in formatting and presentation that can assist the user 102 in parsing and understanding content such as material presented during a lecture.

In certain example embodiments, the biometric data 132 may be provided as an input to the machine learning model 110. The biometric data 132 may be captured by a variety of devices including, without limitation, wearable devices, cameras, microphones, and other sensors. Data captured by such sensors may be processed by the biometrics module(s) 112 to yield the biometric data 132 in a format that is useable by the machine learning model 110.

The biometric data 132 may include, for example, heart rate data captured by a wearable device such as a smartwatch or a fitness tracker. The machine learning model 110 may evaluate the heart rate data to correlate the user's heart rate with characteristics of the content the user 102 is consuming. For instance, the machine learning model 110 may identify, from the heart rate data, subject matter, content formatting, content organization, or the like that corresponds to increases in the user's 102 heart rate above an average or median heart rate of the user 102, which may reflect nervousness and a lack of comprehension by the user 102. The machine learning model 110 may determine that those characteristics that correspond to an increase in the user's 102 heart rate should be avoided for the user 102, and this insight may be incorporated into the customized user profile 136 such that future content presented to the user may be modified to exclude such characteristics. In certain example embodiments, the customized user profile 136 may indicate that such content characteristics should be avoided for the user 102 if the heart rate data indicates an increase in the user's 102 heart rate of at least a threshold value when the user 102 is presented with content having such characteristics. Similarly, the machine learning model 110 may determine that those content characteristics that correspond to stability or a decrease in the user's 102 heart rate are desirable because they reflect a lack of nervousness and better comprehension of the material by the user 102, and this insight may be incorporated into the customized user profile 136 such that future content presented to the user 102 may be modified to include such characteristics.

As another non-limiting example, the biometric data 132 may include optical biometrics such as gaze tracking data indicative of movement and/or gaze directions of the user's eyes. For instance, cameras integrated with the user device 102 or otherwise provided within an environment of the user 102 may capture the gaze tracking data. In addition, the cameras may capture additional optical biometrics such as the amount of dilation of the user's 102 eyes The machine learning model 110 may evaluate the optical biometrics data to gain further insights with respect to the user's 102 learning style/preferences. For instance, if the optical biometrics data indicates that the user's 102 gaze direction remains focused on a particular portion of the display of the user device 104 for at least a threshold amount of time, the machine learning model 110 may determine that the user 102 is struggling to comprehend content being displayed at that portion of the display. This information may be incorporated into the customized user profile 136 such that similar content presented to the user 102 may be modified, supplemented, or enhanced with supplementary content to reinforce the material.

As another non-limiting example, the type of content or the form in which content is presented may be evaluated with respect to the user's 102 gaze direction to confirm or change the user's 102 preferred learning style first identified during generation of the baseline user profile 122. For instance, if the user's 102 gaze direction remains focused on diagrams, tables, charts, or the like for at least a threshold period of time (or for a threshold period of time more than other portions of content displayed on the user device 102 or otherwise presented to the user 102), the machine learning model 110 may determine that the user 102 is a visual learner. Alternatively, if the user 102 tends to consume content in audio form (e.g., playing audio snippets presented as part of the content) and/or if the user's 102 gaze direction remains focused on a lecturer for at least a threshold period of time during a lecture, the machine learning model 110 may determine that the user 102 is an auditory learner. Such determinations may either confirm or negate the user's 102 learning style first identified during the creation of the baseline user profile 122 and may be reflected in the customized user profile 136.

In certain example embodiments, the machine learning model 110 may also receive processed speech data 134 generated by the one or more natural language/speech processing modules 114 as input. Various sensors (e.g., microphones) may capture audio data within the classroom environment. The audio data may include, for example, data indicative of a lecturer's speech. The natural language/speech processing module(s) 114 may process the speech data to identify changes in the pitch and/or tone of the speaker; changes in the decibel level of the speaker; and so forth. Particular tones, pitches, and/or decibel levels may be indicative of critical concepts. In addition, the natural language/speech processing module(s) 114 may analyze the speech data to identify redundancies (e.g., repetitive speech), which may be indicative of an attempt by the lecturer to reinforce particular critical concepts.

The results of the processing performed by the natural language/speech processing module(s) 114 may be reflected in the processed speech data 134 provided as input to the machine learning model 110. In certain example embodiments, the machine learning model 110 may compare the processed speech data 134 to the biometric data 132, for example, to gain further insights into the user's 102 learning style/preferences. For example, if the biometric data 132 indicates that the user's 102 gaze direction is not focused on the lecturer during periods in which the speaker's tone, pitch, and/or decibel level reflects a presentation of critical concepts, the machine learning model 110 may determine that the user 102 is not an auditory learner. As another example, the biometric data 132 may indicate that the user's 102 gaze direction is focused on the speaker when the speaker's speech has a certain tone, pitch, and/or decibel level but not at other times. The machine learning model 110 may then determine, for example, that the user 102 is more likely to be engaged in the lecture when the speaker is more dynamic and animated; that the user 102 requires additional supplemental content to reinforce concepts that correspond to periods of time when the user 102 is not focused on the speaker; that the user 102 prefers certain content presented in auditory form but prefers other content to be presented in another medium; and so forth.

In certain example embodiments, the machine learning model 110 may analyze different inputs in conjunction with one another to distinguish between scenarios in which the user 102 is focused on material because the user 102 is engaged with and comprehending the material and scenarios in which the user 102 is focused on material because the user 102 is having difficulty comprehending the material. For instance, in certain example embodiments, data indicative of a user's gaze direction may be insufficient to distinguish between these scenarios. As such, additional data (e.g., biometric data indicative of dilation of the user's 102 pupils) may be used to confirm whether the user's 102 gaze direction being focused on particular content indicates engagement with the material or difficulty comprehending the material. For example, sustained dilation of the user's 102 pupils together with little or no change in the gaze direction of the user 102 for a threshold period of time may indicate difficulty comprehending the material. On the other hand, little or no dilation of the user's 102 pupils while the user's 102 gaze direction remains relatively fixed may indicate engagement with and comprehension of the material.

The machine learning model 110 may continually receive the above-described inputs over time such that the customized user profile 136 for the user 102 can be continually updated and refined to more closely align with the user's 102 learning style/preferences, which may also evolve over time or which may be different based on the subject matter of the material being consumed. That is, the machine learning model 110 may be configured to constantly adapt to changing environmental inputs to produce a customized user profile 136 that is adaptive to the user's 102 learning habits over time.

Referring again to FIG. 2, after the customized user profile 136 is generated, computer-executable instructions of one or more content organization module(s) 116 may be executed at block 214 of the method 200 to customize content 138 in accordance with the customized user profile 136 in order to obtain customized content 140, which may then be presented to the user 102 at block 216 of the method 200. The content 138 may include content that may be presented in environments such as classrooms, lecture halls, meetings, or the like. The content 138 may include text, other visual content (e.g., tables, diagrams, charts, pictures, video, etc.), or the like that may be capable of being presented to the user 102 via the client application executing on the user device 104, for example. The content 138 may further include auditory content such a lecturer's speech, speech associated with the user 102, speech associated with other users within the environment, and so forth.

The content organization module(s) 116 may be configured to modify, enhance, and/or supplement the content 138 in accordance with the customized user profile 136 to generate customized content 140 that is better tailored to the particular learning style/preferences of the user 102 that were identified by the machine learning model 110 and reflected in the customized user profile 136. In particular, various sensors may be utilized to capture information from the user's 102 environment such as verbalized speech of a lecturer. The natural language/speech processing module(s) 114 may then be executed to perform natural language processing of the captured speech to generate processed speech data 134.

As previously described, the processed speech data 114 may identify portions of the speech that are associated with tone(s), pitch(es), and/or decibel level(s) indicative of critical concepts. The content organization module(s) 116 may then organize the content 138 to emphasize, reinforce, and/or supplement the critical concepts in a manner that aligns with the learning style/preferences of the user 102 reflected in the customized user profile 136. For example, if the customized user profile 136 indicates that the user 102 is a visual learner, the content 138 can be modified or supplemented with visual aids such as tables, diagrams, etc. to produce customized content 140 that reinforces the critical concepts through such visual aids. As another non-limiting example, if the customized user profile 136 indicates that the user 102 is an auditory learner, the content 138 may be modified or supplemented with audio snippets that present the critical concepts in a concise and easily consumable way. Such audio snippets may be included in the customized content 140. In certain example embodiments, if the customized user profile 136 indicates that the user 102 is an auditory learner or is easily distracted by auditory input, an auditory system can be used to eliminate outside stimuli, or alternatively, to generate white noise/music to help the user 102 focus. As yet another non-limiting example, the content 138 may be reformatted or organized to produce customized content 140 that matches preferences of the user 102 identified in the customized user profile 136, which may have been gleaned from historical assessment data 128, media usage data 130, or the like associated with the user 102, as previously described.

While the use of biometric data 132 in an offline manner by the machine learning model 110 to generate the customized user profile 136 has been previously described, in certain example embodiments, biometric data 132 may also be captured in real-time and used by the content organization module(s) 116 to modify, enhance, and/or supplement the content 138 to produce the customized content 140. For example, gaze tracking data, heart rate data, or the like may be captured in real-time and may be used to identify concepts that the user 102 is potentially having difficult comprehending. The content organization module(s) 116 may then make modifications to the content 138 and/or supplement the content 138 to present such concepts in a form that is better suited to the user's 102 learning style/preferences.

Example embodiments of the disclosure enable the content organization module(s) 116 to utilize a customized user profile 136 to modify, supplement, and/or enhance content 138 to generate customized content 140 that is specifically tailored to the user's 102 learning style/preferences. The customized content 140 may be specifically tailored to the user's 102 learning style/preferences in any of a variety of ways. For example, the customized content 140 may include additional content that is formatted and organized similarly to content that the customized user profile 136 indicates the user 102 is best able to grasp; may eliminate portions of the content 138 that are likely to confuse the user 102; may include material presented in a different format if the user 102 is failing to understand something presented in a particular format in the content 138; and so forth.

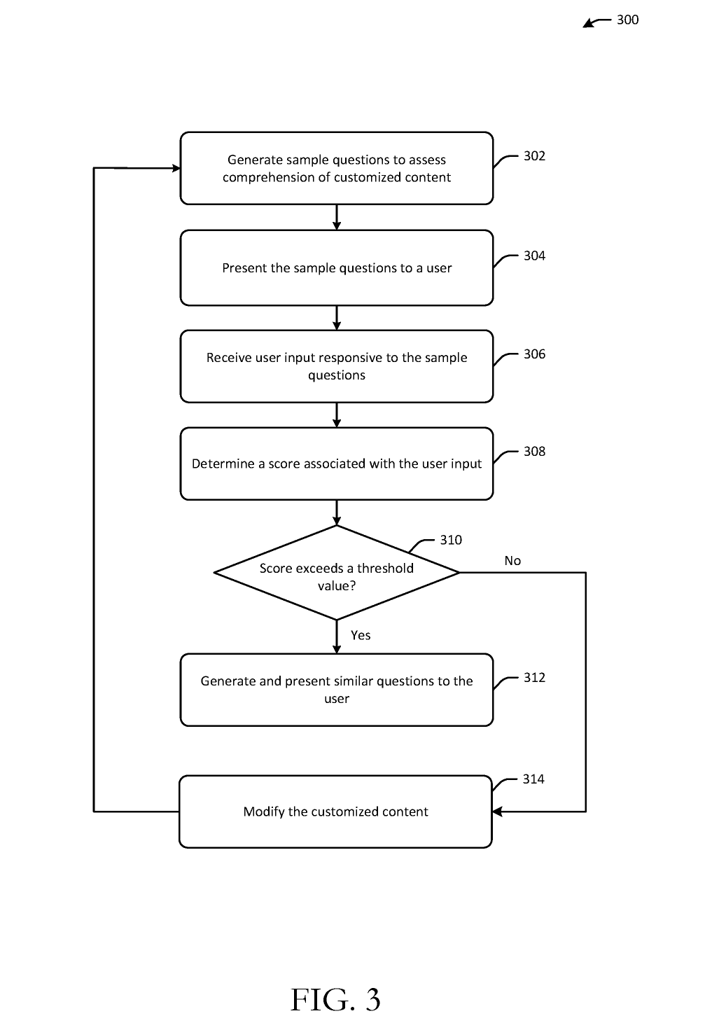

FIG. 3 is a process flow diagram of an illustrative method 300 for assessing a comprehension level of a user with respect to customized content presented to the user in accordance with one or more example embodiments of the disclosure. FIG. 3 will be described in conjunction with FIG. 1 hereinafter. The method 300 may be performed, for example, to assess the user's 102 comprehension of the customized content 140 and to determine whether the customized content 140 should be further modified to better align with the user's 102 learning style/preferences.

At block 302 of the method 300, computer-executable instructions of the content organization module(s) 116 may be executed to generate sample questions to assess comprehension of the customized content 140 by the user 102. The sample questions may include any suitable question designed to assess the user's 102 comprehension of one or more concepts presented in the customized content 140.

At block 304 of the method 300, the sample questions may be presented to the user 102. The sample questions may be presented via a user interface of the client application executing on the user device 104. At block 306 of the method 300, user input may be received from the user 102. The user input may include responses provided by the user 102 to the sample questions. The user input may be received from the user 102 via the user interface of the client application executing on the user device 104.

At block 308 of the method 300, computer-executable instructions of the content organization module(s) 116 may be executed to determine a score associated with the user input received at block 304. In certain example embodiments, the score may be a simply tally of the number or percentage of correct responses provided by the user 102 to the sample questions. In other example embodiments, the score may be generated by applying a more complex scoring algorithm to the user responses. The scoring algorithm may take into account any number of factors such as, for example, the number or percentage of correct responses, the amount of time required to provide the correct responses, and so forth. In addition, various factors may be weighted differently by the scoring algorithm. For example, certain questions may be assigned a higher point value such that correct responses to such questions are weighted more heavily by the scoring algorithm.

At block 310 of the method 300, computer-executable instructions of the content organization module(s) 116 may be executed to determine whether the score meets or exceeds a threshold value. In response to a positive determination at block 310 (which may indicate a suitable level of comprehension of the customized content 140 by the user 102), additional questions that are similar in form, organization, and/or content to the sample questions may be presented to the user 102 at block 312 of the method 300 to further reinforce concepts included in the customized content 140.

On the other hand, in response to a negative determination at block 310 (which may indicate an inadequate level of comprehension of the customized content 140 by the user 102), computer-executable instructions of the content organization module(s) 116 may be executed at block 314 of the method 300 to modify the customized content 140. The customized content 140 may be modified in any of the ways previously described in order to better align the customized content 140 with the user's 102 learning style/preferences. From block 314, the method 300 may again proceed from block 302, where sample questions may be generated to assess the user's 102 comprehension of the modified customized content.

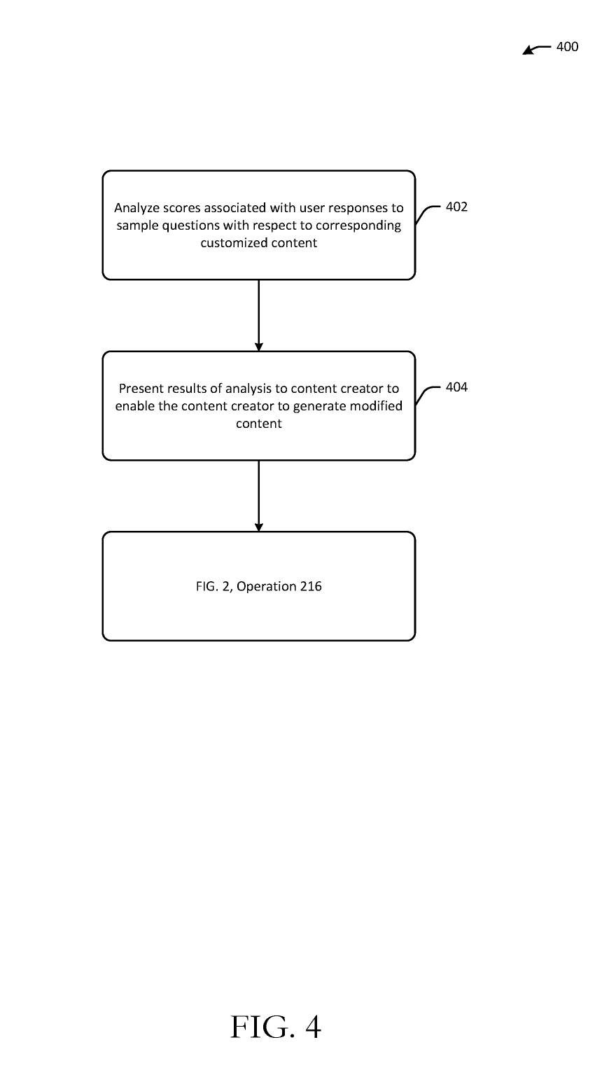

FIG. 4 is a process flow diagram of an illustrative method 400 for providing data to a content creator to enable the content creator to modify the content to enhance user comprehension in accordance with one or more example embodiments of the disclosure.

At block 402 of the method 400, computer-executable instructions of the content organization module(s) 116 may be executed to analyze scores associated with user responses to sample questions with respect to corresponding customized content. The scores may indicate varying degrees of comprehension by the user 102 of various customized content. At block 404 of the method, the results of the analysis performed at block 402 may be presented to a content creator to enable the content creator to generate modified content. For example, the results of the analysis may be presented to a course lecturer, who may evaluate the results to identify subject matter, the medium in which the subject matter is presented, the formatting/organization of the subject matter, and so forth that the user 102 comprehends well or comprehends poorly. The lecturer may then modify her lecture materials to reinforce those concepts that the user 102 comprehends well and/or to alter the manner in which concepts that the user 102 understands poorly are presented. The method 400 may then proceed from block 216 of FIG. 2, where the modified content is presented to the user 102.

An example use case to which embodiments of the disclosure are applicable involves a student user in a classroom or lecture environment. In such an example scenario, a lecturer may present a course lecture on a given subject. The natural language/speech processing module(s) 114 may capture the lecturer's speech and transcribe the captured speech into text format. Example embodiments of the disclosure, however, go beyond simply transforming the information into a readable format, but also organize the lecture content in a manner that optimally aligns with the user's 102 learning style/preferences derived by the machine learning model 110 and reflected in the customized user profile 136 associated with the user 102.

In certain example embodiments, the machine learning model 110 may associate trends in the speaker's tone with significant concepts and ideas that are being discussed. This function can adapt over time, becoming more fine-tuned to how the speaker's tone relates to the importance of the information conveyed, and ultimately leading to a distinguishing of critical ideas from general content. Once critical concepts have been identified, supplementary information can be leveraged from various sources, allowing for additional educational resources to be automatically incorporated into a student's set of notes, for example. If the user 102 designates that a lecture is for a class at school, for example, then sample questions may be generated and presented to the user 102 in the form of a practice test or the like designed to assess the user's comprehension level. The user's 102 responses to the practice questions may be scored, and the score can be analyzed to determine the efficacy of the content and the manner in which it is presented in improving the comprehension of the user 102. If the score is high (e.g., meets or exceeds a threshold value), similar questions can be generated and presented to the user 102 to enable the user 102 to continue to reinforce the concepts. If the score is low, the content may be reorganized to better fit the student's needs.

Further, as previously described, biometric data 132, such as the user's 102 eye movement, may be captured and used to further refine the content presented to the user 102. For example, depending on how long the user 102 focuses on particular portions of the content, the client application may query the user 102 as to whether he understands the information being presented and would like further information to be provided with a similar format and organization, or alternatively, whether the user 102 would like the content presented in a different way.

In addition, the client application may be used by a content creator (e.g., a lecturer) to receive feedback directly from students on areas of confusion and/or feedback in the form of students' responses to practice test questions. The lecturer may utilize this feedback to determine which concepts may need reinforcement and which concepts may need to be explained differently. Moreover, the content customization engine 106 may also be configured to determine which students were most interested in the content so that future lessons can be tailored to capture a majority interest.

Another example use case to which example embodiments of the disclosure are applicable involves special education settings. Based on the customized user profile associated with a special education student, reading and vocabulary levels of the student may be taken into account when transcribing notes. Certain concepts may be re-worded and sentence structure may be altered to tailor the content to each individual student's needs. The students may also be directed to sources (e.g., online sources) that provide supplemental information and/or extra assistance.

One or more illustrative embodiments of the disclosure are described herein. Such embodiments are merely illustrative of the scope of this disclosure and are not intended to be limiting in any way. Accordingly, variations, modifications, and equivalents of embodiments disclosed herein are also within the scope of this disclosure.

FIG. 5 is a schematic diagram of an illustrative networked architecture 500 configured to implement one or more example embodiments of the disclosure. In the illustrative implementation depicted in FIG. 5, the networked architecture 500 includes one or more user devices 502 and one or more content customization servers 504. The user device(s) 502 may include any of the types of devices described in connection with the user device 104 depicted in FIG. 1. The user device(s) 502 may be configured to communicate with the content customization server(s) 504 via one or more networks 506. In addition, the content customization server(s) 504 and/or the user device(s) 502 may access one or more datastores 536 over the network(s) 506. While any particular component of the networked architecture 500 may be described herein in the singular, it should be appreciated that multiple instances of any such component may be provided, and functionality described in connection with a particular component may be distributed across multiple ones of such a component.

The network(s) 506 may include, but are not limited to, any one or more different types of communications networks such as, for example, cable networks, public networks (e.g., the Internet), private networks (e.g., frame-relay networks), wireless networks, cellular networks, telephone networks (e.g., a public switched telephone network), or any other suitable private or public packet-switched or circuit-switched networks. The network(s) 506 may have any suitable communication range associated therewith and may include, for example, global networks (e.g., the Internet), metropolitan area networks (MANs), wide area networks (WANs), local area networks (LANs), or personal area networks (PANs). In addition, the network(s) 506 may include communication links and associated networking devices (e.g., link-layer switches, routers, etc.) for transmitting network traffic over any suitable type of medium including, but not limited to, coaxial cable, twisted-pair wire (e.g., twisted-pair copper wire), optical fiber, a hybrid fiber-coaxial (HFC) medium, a microwave medium, a radio frequency communication medium, a satellite communication medium, or any combination thereof.

In an illustrative configuration, the content customization server 504 may include one or more processors (processor(s)) 508, one or more memory devices 510 (generically referred to herein as memory 510), one or more input/output (“I/O”) interface(s) 512, one or more network interfaces 514, and data storage 518. The content customization server 504 may further include one or more buses 516 that functionally couple various components of the content customization server 504. The user device 502 may include similar hardware, firmware, and/or software components as the content customization server 504. In certain example embodiments, at least a portion of the processing performed by components of the content customization server 504 (e.g., processing performed by program modules of the content customization engine 524) may be performed in a distributed manner by the user device 502 and the content customization server 504.

The bus(es) 516 may include at least one of a system bus, a memory bus, an address bus, or a message bus, and may permit the exchange of information (e.g., data (including computer-executable code), signaling, etc.) between various components of the content customization server 504. The bus(es) 516 may include, without limitation, a memory bus or a memory controller, a peripheral bus, an accelerated graphics port, and so forth. The bus(es) 516 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

The memory 510 may include volatile memory (memory that maintains its state when supplied with power) such as random access memory (RAM) and/or non-volatile memory (memory that maintains its state even when not supplied with power) such as read-only memory (ROM), flash memory, ferroelectric RAM (FRAM), and so forth. Persistent data storage, as that term is used herein, may include non-volatile memory. In certain example embodiments, volatile memory may enable faster read/write access than non-volatile memory. However, in certain other example embodiments, certain types of non-volatile memory (e.g., FRAM) may enable faster read/write access than certain types of volatile memory.

In various implementations, the memory 510 may include multiple different types of memory such as various types of static random access memory (SRAM), various types of dynamic random access memory (DRAM), various types of unalterable ROM, and/or writeable variants of ROM such as electrically erasable programmable read-only memory (EEPROM), flash memory, and so forth. The memory 510 may include main memory as well as various forms of cache memory such as instruction cache(s), data cache(s), translation lookaside buffer(s) (TLBs), and so forth. Further, cache memory such as a data cache may be a multi-level cache organized as a hierarchy of one or more cache levels (L1, L2, etc.).

The data storage 518 may include removable storage and/or non-removable storage including, but not limited to, magnetic storage, optical disk storage, and/or tape storage. The data storage 518 may provide non-volatile storage of computer-executable instructions and other data. The memory 510 and the data storage 518, removable and/or non-removable, are examples of computer-readable storage media (CRSM) as that term is used herein.

The data storage 518 may store computer-executable code, instructions, or the like that may be loadable into the memory 510 and executable by the processor(s) 508 to cause the processor(s) 508 to perform or initiate various operations. The data storage 518 may additionally store data that may be copied to memory 510 for use by the processor(s) 508 during the execution of the computer-executable instructions. Moreover, output data generated as a result of execution of the computer-executable instructions by the processor(s) 508 may be stored initially in memory 510 and may ultimately be copied to data storage 518 for non-volatile storage.

More specifically, the data storage 518 may store one or more operating systems (O/S) 520; one or more database management systems (DBMS) 522 configured to access the memory 510 and/or the datastore(s) 536; and one or more program modules, applications, engines, managers, computer-executable code, scripts, or the like such as, for example, a content customization engine 524, which may, in turn, include one or more profile generation modules 526, a machine learning model 528, one or more biometrics modules 530, one or more natural language/speech processing modules 532, and one or more content organization modules 534. Any of the components depicted as being stored in data storage 518 may include any combination of software, firmware, and/or hardware. The software and/or firmware may include computer-executable instructions (e.g., computer-executable program code) that may be loaded into the memory 510 for execution by one or more of the processor(s) 508 to perform any of the operations described earlier in connection with correspondingly named modules, engines, managers, or the like.

Although not depicted in FIG. 5, the data storage 518 may further store various types of data utilized by components of the content customization server 504 (e.g., any of the data depicted in FIG. 1). Any data stored in the data storage 518 may be loaded into the memory 510 for use by the processor(s) 508 in executing computer-executable instructions. In addition, any data stored in the data storage 518 may potentially be stored in the datastore(s) 536 and may be accessed via the DBMS 522 and loaded in the memory 510 for use by the processor(s) 508 in executing computer-executable instructions.

The processor(s) 508 may be configured to access the memory 510 and execute computer-executable instructions loaded therein. For example, the processor(s) 508 may be configured to execute computer-executable instructions of the various program modules, applications, engines, managers, or the like of the content customization server 504 to cause or facilitate various operations to be performed in accordance with one or more embodiments of the disclosure. The processor(s) 508 may include any suitable processing unit capable of accepting data as input, processing the input data in accordance with stored computer-executable instructions, and generating output data. The processor(s) 508 may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 508 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor(s) 508 may be capable of supporting any of a variety of instruction sets.

Referring now to other illustrative components depicted as being stored in the data storage 518, the O/S 520 may be loaded from the data storage 518 into the memory 510 and may provide an interface between other application software executing on the content customization server 504 and hardware resources of the content customization server 504. More specifically, the O/S 520 may include a set of computer-executable instructions for managing hardware resources of the content customization server 504 and for providing common services to other application programs. In certain example embodiments, the O/S 520 may include or otherwise control execution of one or more of the program modules, engines, managers, or the like depicted as being stored in the data storage 518. The O/S 520 may include any operating system now known or which may be developed in the future including, but not limited to, any server operating system, any mainframe operating system, or any other proprietary or non-proprietary operating system.

The DBMS 522 may be loaded into the memory 510 and may support functionality for accessing, retrieving, storing, and/or manipulating data stored in the memory 510, data stored in the data storage 518, and/or data stored in the datastore(s) 536. The DBMS 522 may use any of a variety of database models (e.g., relational model, object model, etc.) and may support any of a variety of query languages. The DBMS 522 may access data represented in one or more data schemas and stored in any suitable data repository. External datastore(s) 536 that may be accessible by the content customization server 504 via the DBMS 522 may include, but are not limited to, databases (e.g., relational, object-oriented, etc.), file systems, flat files, distributed datastores in which data is stored on more than one node of a computer network, peer-to-peer network datastores, or the like. The datastore(s) 536 may include the datastore(s) 124 depicted in FIG. 1.

Referring now to other illustrative components of the content customization server 504, the input/output (I/O) interface(s) 512 may facilitate the receipt of input information by the content customization server 504 from one or more I/O devices as well as the output of information from the content customization server 504 to the one or more I/O devices. The I/O devices may include any of a variety of components such as a display or display screen having a touch surface or touchscreen; an audio output device for producing sound, such as a speaker; an audio capture device, such as a microphone; an image and/or video capture device, such as a camera; a haptic unit; and so forth. Any of these components may be integrated into the content customization server 504 or may be separate. The I/O devices may further include, for example, any number of peripheral devices such as data storage devices, printing devices, and so forth.

The I/O interface(s) 512 may also include an interface for an external peripheral device connection such as universal serial bus (USB), FireWire, Thunderbolt, Ethernet port or other connection protocol that may connect to one or more networks. The I/O interface(s) 512 may also include a connection to one or more antennas to connect to one or more networks via a wireless local area network (WLAN) (such as Wi-Fi) radio, Bluetooth, and/or a wireless network radio, such as a radio capable of communication with a wireless communication network such as a Long Term Evolution (LTE) network, WiMAX network, 3G network, etc.

The content customization server 504 may further include one or more network interfaces 514 via which the content customization server 504 may communicate with any of a variety of other systems, platforms, networks, devices, and so forth. The network interface(s) 514 may enable communication, for example, with one or more other devices via one or more of the network(s) 506.

It should be appreciated that the program modules depicted in FIG. 5 as being stored in the data storage 518 are merely illustrative and not exhaustive and that processing described as being supported by any particular module may alternatively be distributed across multiple modules, engines, or the like, or performed by a different module, engine, or the like. In addition, various program module(s), script(s), plug-in(s), Application Programming Interface(s) (API(s)), or any other suitable computer-executable code hosted locally on the content customization server 504, a user device 502, and/or other computing devices accessible via the network(s) 506, may be provided to support functionality provided by the modules depicted in FIG. 5 and/or additional or alternate functionality. Further, functionality may be modularized in any suitable manner such that processing described as being performed by a particular module may be performed by a collection of any number of program modules, or functionality described as being supported by any particular module may be supported, at least in part, by another module. In addition, program modules that support the functionality described herein may be executable across any number of cluster members in accordance with any suitable computing model such as, for example, a client-server model, a peer-to-peer model, and so forth. In addition, any of the functionality described as being supported by any of the modules depicted in FIG. 5 may be implemented, at least partially, in hardware and/or firmware across any number of devices.

It should further be appreciated that the content customization server 504 and/or the user device 502 may include alternate and/or additional hardware, software, or firmware components beyond those described or depicted without departing from the scope of the disclosure. More particularly, it should be appreciated that software, firmware, or hardware components depicted as forming part of the content customization server 504 are merely illustrative and that some components may not be present or additional components may be provided in various embodiments. While various illustrative modules have been depicted and described as software modules stored in data storage 518, it should be appreciated that functionality described as being supported by the modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional program modules and/or engines not depicted may be present and may support at least a portion of the described functionality and/or additional functionality.

One or more operations of the methods 200-400 may be performed by a content customization server 504 having the illustrative configuration depicted in FIG. 5, or more specifically, by one or more program modules, engines, applications, or the like executable on such a device. It should be appreciated, however, that such operations may be implemented in connection with numerous other device configurations.

The operations described and depicted in the illustrative methods of FIGS. 2-4 may be carried out or performed in any suitable order as desired in various example embodiments of the disclosure. Additionally, in certain example embodiments, at least a portion of the operations may be carried out in parallel. Furthermore, in certain example embodiments, less, more, or different operations than those depicted in FIGS. 2-4 may be performed.

Although specific embodiments of the disclosure have been described, one of ordinary skill in the art will recognize that numerous other modifications and alternative embodiments are within the scope of the disclosure. For example, any of the functionality and/or processing capabilities described with respect to a particular system, system component, device, or device component may be performed by any other system, device, or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure. In addition, it should be appreciated that any operation, element, component, data, or the like described herein as being based on another operation, element, component, data, or the like may be additionally based on one or more other operations, elements, components, data, or the like. Accordingly, the phrase “based on,” or variants thereof, should be interpreted as “based at least in part on.”

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for generating customized content, the method comprising:
generating a baseline user profile for a user;
providing the baseline user profile as input to a machine learning model;
providing additional input to the machine learning model, wherein the additional input comprises at least one of social media data, biometric data, or processed speech data;
generating a customized user profile for the user based at least in part on the baseline user profile and the additional input;
customizing content based at least in part on the customized user profile to obtain the customized content for the user; and
presenting the customized content to the user.

2. The computer-implemented method of claim 1, further comprising:
presenting diagnostic prompts to the user via a user interface of an application executing, at least in part, on a user device; and
receiving user input via the user interface of the application, wherein the user input is responsive, at least in part, to the diagnostic prompts,
wherein the generating the baseline user profile comprises generating the baseline user profile based at least in part on the user input.

3. The computer-implemented method of claim 2, wherein the diagnostic prompts comprise queries to the user designed to assess a learning style of the user.

4. The computer-implemented method of claim 3, wherein the customized user profile for the user is indicative of one or more modifications to be made to the content to reinforce the learning style of the user, and wherein customizing the content comprises making the one or more modifications to the content to obtain the customized content.

5. The computer-implemented method of claim 3, further comprising:
generating the processed speech data, wherein generating the processed speech data comprises:
identifying speech detected by one or more sensors of a user device of the user; and
processing the speech to determine a tone of the speech, wherein the processed speech data is indicative of the tone of the speech; and
determining that the speech corresponds to a critical concept,
wherein customizing the content comprises customizing the content to emphasize the critical concept in the customized content with respect to the learning style of the user, wherein customizing the content comprises at least one of generating an audio snippet of the speech or emphasizing text in the content directed to the critical concept.

6. The computer-implemented method of claim 3, further comprising:
generating the biometric data, wherein generating the biometric data comprises determining a period of time that a gaze direction of the user aligns with a portion of text in the content, wherein the gaze direction of the user is detected using one or more sensors of a user device of the user, and wherein the biometric data is indicative of the period of time; and
determining that the period of time exceeds a threshold amount of time indicative of difficulty comprehending subject matter of the text,
wherein customizing the content comprises modifying the text to enhance comprehension of the subject matter by the user with respect to the learning style of the user.

7. The computer-implemented method of claim 1, further comprising:
presenting queries to the user to assess comprehension of the customized content;
receiving user input to the queries;
determining a score associated with the user input;
determining that the score fails to satisfy a threshold value; and
modifying the customized content based at least in part on the user input.

8. A system for generating customized content, the system comprising:
at least one memory storing computer-executable instructions; and
at least one processor configured to access the at least one memory and execute the computer-executable instructions to:
generate a baseline user profile for a user;
provide the baseline user profile as input to a machine learning model;
provide additional input to the machine learning model, wherein the additional input comprises at least one of social media data, biometric data, or processed speech data;
generate a customized user profile for the user based at least in part on the baseline user profile and the additional input;
customize content based at least in part on the customized user profile to obtain the customized content for the user; and
present the customized content to the user.

9. The system of claim 8, wherein the at least one processor is further configured to execute the computer-executable instructions to:
present diagnostic prompts to the user via a user interface of an application executing, at least in part, on a user device; and
receive user input via the user interface of the application, wherein the user input is responsive, at least in part, to the diagnostic prompts, and
wherein the at least one processor is configured to generate the baseline user profile by executing the computer-executable instructions to generate the baseline user profile based at least in part on the user input.

10. The system of claim 9, wherein the diagnostic prompts comprise queries to the user designed to assess a learning style of the user.

11. The system of claim 10, wherein the customized user profile for the user is indicative of one or more modifications to be made to the content to reinforce the learning style of the user, and wherein the at least one processor is configured to customize the content by executing the computer-executable instructions to make the one or more modifications to the content to obtain the customized content.

12. The system of claim 10, wherein the at least one processor is further configured to execute the computer-executable instructions to:
generate the processed speech data, wherein generating the processed speech data comprises:
identifying speech detected by one or more sensors of a user device of the user; and
processing the speech to determine a tone of the speech, wherein the processed speech data is indicative of the tone of the speech; and
determine that the speech corresponds to a critical concept,
wherein the at least one processor is configured to customize the content by executing the computer-executable instructions to customize the content to emphasize the critical concept in the customized content with respect to the learning style of the user by at least one of generating an audio snippet of the speech or emphasizing text in the content directed to the critical concept.

13. The system of claim 10, wherein the at least one processor is further configured to execute the computer-executable instructions to:
generate the biometric data, wherein generating the biometric data comprises determining a period of time that a gaze direction of the user aligns with a portion of text in the content, wherein the gaze direction of the user is detected using one or more sensors of a user device of the user, and wherein the biometric data is indicative of the period of time; and
determine that the period of time exceeds a threshold amount of time indicative of difficulty comprehending subject matter of the text,
wherein the at least one processor is configured to customize the content by executing the computer-executable instructions to modify the text to enhance comprehension of the subject matter by the user with respect to the learning style of the user.

14. The system of claim 8, wherein the at least one processor is further configured to execute the computer-executable instructions to:
present queries to the user to assess comprehension of the customized content;
receive user input to the queries;
determine a score associated with the user input;
determine that the score fails to satisfy a threshold value; and
modify the customized content based at least in part on the user input.

15. A computer program product for generating customized content, the computer program product comprising a storage medium readable by a processing circuit, the storage medium storing instructions executable by the processing circuit to cause a method to be performed, the method comprising:
generating a baseline user profile for a user;
providing the baseline user profile as input to a machine learning model;
providing additional input to the machine learning model, wherein the additional input comprises at least one of social media data, biometric data, or processed speech data;
generating a customized user profile for the user based at least in part on the baseline user profile and the additional input;
customizing content based at least in part on the customized user profile to obtain the customized content for the user; and
presenting the customized content to the user.

16. The computer program product of claim 15, the method further comprising:
presenting diagnostic prompts to the user via a user interface of an application executing, at least in part, on a user device, wherein the diagnostic prompts comprise queries to the user designed to assess a learning style of the user; and
receiving user input via the user interface of the application, wherein the user input is responsive, at least in part, to the diagnostic prompts,
wherein the generating the baseline user profile comprises generating the baseline user profile based at least in part on the user input.

17. The computer program product of claim 16, wherein the customized user profile for the user is indicative of one or more modifications to be made to the content to reinforce the learning style of the user, and wherein customizing the content comprises making the one or more modifications to the content to obtain the customized content.

18. The computer program product of claim 17, the method further comprising:
generating the processed speech data, wherein generating the processed speech data comprises:
identifying speech detected by one or more sensors of a user device of the user; and
processing the speech to determine a tone of the speech, wherein the processed speech data is indicative of the tone of the speech; and
determining that the speech corresponds to a critical concept,
wherein customizing the content comprises customizing the content to emphasize the critical concept in the customized content with respect to the learning style of the user, wherein customizing the content comprises at least one of generating an audio snippet of the speech or emphasizing text in the content directed to the critical concept.

19. The computer program product of claim 17, the method further comprising:
generating the biometric data, wherein generating the biometric data comprises determining a period of time that a gaze direction of the user aligns with a portion of text in the content, wherein the gaze direction of the user is detected using one or more sensors of a user device of the user, and wherein the biometric data is indicative of the period of time; and
determining that the period of time exceeds a threshold amount of time indicative of difficulty comprehending subject matter of the text,
wherein customizing the content comprises modifying the text to enhance comprehension of the subject matter by the user with respect to the learning style of the user.

20. The computer program product of claim 15, the method further comprising:
presenting queries to the user to assess comprehension of the customized content;
receiving user input to the queries;
determining a score associated with the user input;
determining that the score fails to satisfy a threshold value; and
modifying the customized content based at least in part on the user input.
